(19) United States
(12) Patent Application Publication
(10) Pub. No.: US 2004/0175461 A1
(43) Pub. Date: Sep. 9, 2004

(54) Vita-blast spray

(76) Inventor: Emily Vermillion Clancy, Troy, VA (US)

Correspondence Address: Emily Vermillion Clancy, 105 Cresmont Road, Troy, VA, 22974, US

(21) Appl. No.: 10/379,491

(22) Filed: Mar. 5, 2003

(51) Int. Cl. A23L 1/30

(52) U.S. Cl. 426/72

(57) ABSTRACT

My invention is different from any other vitamin application, because it takes a simple recipe of already deemed safe ingredients used daily by many people and creates a tasty vitamin spray that is designed to be sprayed on to food. This blast of spray is not intended to be a complete day's supplement of vitamins as recommended by the FDA but to boost the vitamin content of the food it is sprayed on. The spray is designed to blend in or enhance the flavor of the food it is sprayed on and may be used multiple times a day without the risk of overdose because of the low amount of vitamin in each recommended dose.

### BACKGROUND OF THE INVENTION

This invention was created to fill a void in the nutritional vitamin content of “empty vitamin” foods. It is to boost the amount of already existing known healthy vitamins to foods that do not have an amount that would be beneficial to people as suggested by the FDA for “Recommended Daily Allowances.” Although there are vitamin sprays in existence, mine is the first to be applied to food, and mine is the first to contain only a small dosage of dietary vitamins for each recommended dose. This is designed that way, so it may be used multiple times a day without the risk of an overdose. My spray also concentrates on a flavorful non-vitamin tasting spray, so it may blend in or enhance the flavor of the food.

### BRIEF SUMMARY OF THE INVENTION

This invention was born from a parent's want to increase the vitamin content of otherwise “vitamin empty” foods. This spray transforms an “empty vitamin” food such as a cookie and adds more vitamin nutritional value. The recommended serving size of the spray is not intended to fulfill the 100% of the Recommended Daily Values based on a 2,000 calorie diet as described by the FDA. The spray is to merely boost the vitamin content of many popular foods that are consumed today. It also solves the problem of the bad taste of most vitamin supplements because of the higher vitamin quantity in their dosages.

### DETAILED DESCRIPTION OF THE INVENTION

The following are the steps to be taken to produce this spray:

Over medium heat mix:

1 cup water and ½ cup+⅛ cup light corn syrup and ½ tsp. Corn starch

Bring to a low boil. Remove from heat. Allow to cool thoroughly

Add the powder form of the vitamins listed:

| | |
|---|---|
| Vitamin C—1000 | mg |
| Vitamin D3—400 | iu |
| Calcium Citrate—630 | mg |
| Vitamin B-1 (Thiamin Mononitrate)—50 | mg |
| Vitamin B-2 (Riboflavin)—12.5 | mg |
| Vitamin B-3 (Niacinamide)—50 | mg |
| Vitamin B-6 (Pyridoxine Hydrochloride)—12.5 | mg |
| Folate (Folic Acid)—50 | mcg |
| Vitamin B-12 (Cyanocobalamin)—12.5 | mcg |
| Biotin—25 | mcg |
| Panthothenic Acid —50 | mg |
| Calcium (Dibasic Calcium Phosphate &—118 | mg |
| d-calcium Pantothenate) | |
| Vitamin A—(5% as Beta Carotene)—10,000 | iu |
| Vitamin C—120 | mg |
| Vitamin D—800 | iu |
| Vitamin E—60 | iu |
| Thiamin (B-1)—3 | mg |
| Riboflavin (B-2)—3.4 | mg |
| Niacin—40 | mg |
| Vitamin B-6—4 | mg |
| Folic Acid—800 | mcg |
| Vitamin B-12—12 | mcg |
| Pantothenic Acid—20 | mg |

After the vitamins have dissolved, add the flavors in the following amounts:

¼ tsp. Strawberry*, ¼ tsp. Grape**, ¼ tsp. Orange#, ⅛+½ tsp. Vanilla## and 1 tsp. cocoa. Flavors should be added to individual batches.

The above mixture(s) should be placed in a spray bottle to achieve the preferred method of application. The mixture may be sprayed on foods of choice to boost vitamin content. The recommended serving size is 0.6 ml.

This serving size is not intended to fulfill the “Recommended Daily Allowance” based on a 2,000 calorie a day diet. The spray is intended to be used Several times a day to spray on food to boost the vitamin content.

*Strawberry flavor content—citric acid, calcium phosphate, artificial flavor, red 40 and ascorbic acid.

**Grape flavor content—citric acid, artificial flavor, maltodextrin, ascorbic acid, red 40 and blue 1.

#orange flavor content—citric acid, artificial flavor, yellow 6, red 40, calcium Phosphate, ascorbic acid and titanium dioxide for color.

##Vanilla flavor—water, sugar, caramel color, propylene glycol, ethyl vanillin and artificial flavor.

Natural flavors will also be used in replace of the above artificial flavors.

### BRIEF DESCRIPTION OF THE SEVERAL VIEWS OF THE DRAWING

Not Applicable

1) What I claim as my invention is an edible, safe, good tasting multiple flavored spray that contains many of the FDA recommended vitamins in a form that may be sprayed on to foods.

2) What I claim as my invention is the function of the recommended dose of the vitamin spray is to boost the vitamin content of any food.

3) What I claim as my invention is that the recommended dosage of the spray is not intended to be a complete day's supplement of vitamins in the quantity recommended by the FDA.

4) What I claim as my invention is a good tasting vitamin spray that is designed to blend with or enhance the taste of foods without an overwhelming vitamin taste.

5) What I claim as my invention is a vitamin spray that may be used multiple times throughout the day without the risk of an overdose because the vitamin content in the recommended dose is very low.
